(19) United States
(12) Patent Application Publication
(10) Pub. No.: US 2022/0372587 A1
(43) Pub. Date: Nov. 24, 2022

(54) DIRECT REDUCED IRON SYSTEM AND METHOD USING SYNTHETIC COMBUSTION AIR

(71) Applicant: Nucor Corporation, Charlotte, NC (US)

(72) Inventor: Mirmohammadyousef Motamedhashemi, Gonzales, LA (US)

(73) Assignee: Nucor Corporation, Charlotte, NC (US)

(21) Appl. No.: 17/749,443

(22) Filed: May 20, 2022

Related U.S. Application Data
(60) Provisional application No. 63/192,273, filed on May 24, 2021.

(51) Int. Cl. C21B 11/10; B01D 53/62; B01D 53/75; B01D 53/78; C21B 5/00

(52) U.S. Cl. CPC C21B 11/10; B01D 53/62; B01D 53/75; B01D 53/78; C21B 5/001; B01D 2257/504; B01D 2258/025; C21B 2005/005

(57) ABSTRACT

A system and method of direct reduction of iron (DRI) is disclosed, having a reduction unit configured to reduce iron oxides to metallic iron; a process gas heater coupled to the reduction unit, the process gas heater configured to supply the reduction unit directly with a source of heated reducing gas, where the process gas heater is further configured to receive a synthetic combustion air stream for heating the reducing gas, the synthetic combustion air stream comprising a source of oxygen with essentially no nitrogen. A method of carbon dioxide emission reduction from a direct reduction of iron (DRI) process is also disclosed.

### CROSS-REFERENCE TO RELATED APPLICATIONS

This application claims the benefit of U.S. Provisional Application No. 63/192,273 filed on May 24, 2021, the entirety of which is incorporated herein by reference.

### TECHNICAL FIELD

This disclosure is related to methods and systems of direct reducing iron ore using a synthetic combustion air with essentially no nitrogen present therein. In one example, the method includes sequestering of carbon dioxide (CO2). More specifically, the present disclosure relates to a method and system for sequestering carbon dioxide in association with such processes.

### BACKGROUND

Direct reduction of iron (DRI) is a process that generates metallic iron from its oxide ore by removing oxygen from the iron ore using a reducing gas, typically provided from a synthesis gas (“syngas”). Industrially applied DRI processes include HyL, MIDREX, and FINMET. There remains continued interest in manufacturing processes that reduce or eliminate the release of carbon dioxide (carbon dioxide) either directly or indirectly into the atmosphere. Such processes, where carbon dioxide emission to the atmosphere is reduced or eliminated, are generally referred to as “blue” processes, and products produced therefrom are “blue” products. The two main sources of carbon dioxide in a direct reduction of iron process are the carbon dioxide generated by direct reduction reactions (“process gas carbon dioxide”), and the carbon dioxide generated by the combustion reactions (“flue gas carbon dioxide”). In both cases, carbon dioxide is inevitably mixed with other gases, thus capturing it requires using separation units being highly selective towards carbon dioxide. While selective separation of carbon dioxide from syngas streams has become a mature technology over the past decades, capturing carbon dioxide from flue gas streams has been more limited mainly due to the high required capital and operating costs along with technical difficulties associated to a high concentration of nitrogen (N2) in conventional combustion air and the low pressure of flue gas streams.

### SUMMARY

In one example, a system for reduction of metal oxides is provided, the system comprising a reduction unit configured to reduce iron oxides to metallic iron, a process gas heater coupled to the reduction unit, the process gas heater configured to supply the reduction unit directly with a source of heated reducing gas, wherein the process gas heater is further configured to receive a synthetic combustion air stream for heating the reducing gas, the synthetic combustion air stream comprising a source of oxygen with essentially no nitrogen.

In one aspect, the reduction unit provides a top gas stream comprising process carbon dioxide, water, unreacted reducing gas, and unreacted hydrocarbon fuel. In another aspect, alone or in combination with any one of the previous aspects, the system further comprises a top gas scrubber coupled to the reduction unit and a top gas separator coupled to the top gas scrubber, wherein the top gas scrubber provides a scrubbed gas stream comprising the process carbon dioxide, the unreacted reducing gas, and the unreacted hydrocarbon fuel to the top gas separator and/or to the process gas heater.

In another aspect, alone or in combination with any one of the previous aspects, the top gas separator provides a first stream from at least two streams, the first stream comprising the unreacted reducing gas and the unreacted hydrocarbon fuel with essentially no process carbon dioxide, and a second stream from the at least two streams, the second stream comprising essentially the process carbon dioxide.

In another aspect, alone or in combination with any one of the previous aspects, the first stream is provided directly or indirectly to the process gas heater, alone or in combination with additional hydrocarbon fuel. In another aspect, alone or in combination with any one of the previous aspects, the second stream is combined with the source of oxygen.

In another aspect, alone or in combination with any one of the previous aspects, the top gas separator is a pressure swing absorption unit (PSA), chemical absorption unit, or vacuum pressure swing absorption unit (VPSA). In another aspect, alone or in combination with any one of the previous aspects, the source of oxygen of the synthetic combustion air is provided by a cryogenic separator, a membrane separator, a pressure swing absorption unit (PSA), a vacuum pressure swing absorption unit (VPSA), a fractional distiller, or air separation unit (ASU).

In another aspect, alone or in combination with any one of the previous aspects, the system further comprises a flue gas scrubber configured to receive flue gas comprising the process carbon dioxide and flue gas carbon dioxide, the flue gas scrubber providing a carbon dioxide rich stream.

In another aspect, alone or in combination with any one of the previous aspects, at least a portion of the flue gas stream is mixed with the synthetic combustion air.

In another aspect, alone or in combination with any one of the previous aspects, the system further comprises a drying unit configured to receive the carbon dioxide rich stream and/or further comprising a compressor configured to receive and compress the carbon dioxide rich stream. In another aspect, alone or in combination with any one of the previous aspects, the compressor is configured to provide supercritical carbon dioxide to a geological sequestering pipeline. In another aspect, alone or in combination with any one of the previous aspects, the geological sequestering pipeline is coupled to one or more subterranean oil reservoirs, natural gas deposits, un-mineable coal deposits, saline formations, shale, and basalt formations.

In another aspect, alone or in combination with any one of the previous aspects, the system, further comprises an electric arc furnace configured to receive the metallic iron. In another aspect, alone or in combination with any one of the previous aspects, the electric arc furnace is configured to receive the metallic iron continuously or semi-continuously.

In another aspect, alone or in combination with any one of the previous aspects, the system is absent a reformer unit.

In another example a method of direct reduction of iron (DRI) in a reduction unit configured to reduce iron oxides to metalized iron is provided, the method comprising providing to a reduction unit a source of heated reducing gas from a process gas heater, producing a top gas stream comprising process carbon dioxide, unreacted reducing gas, unreacted hydrocarbon fuel, and water, providing a synthetic combustion air stream to the process gas heater, the synthetic combustion air stream comprising a source of oxygen with essentially no nitrogen, and reducing iron oxides present in the reduction unit to iron metal.

In one aspect, the DRI unit produces a top gas stream comprising process carbon dioxide, unreacted reducing gas, unreacted hydrocarbon fuel, and water and wherein the method further comprises introducing the top gas to top gas separator configured to split the top gas into at least two streams: a first stream comprising the unreacted reducing gas, and the unreacted hydrocarbon fuel with essentially no process carbon dioxide; and a second stream comprising the process carbon dioxide. The method includes combining the first stream with hydrocarbon fuel and sending to the process gas heater and/or combining the second stream with the source of oxygen and sending to the process gas heater, where the process gas heater provides a flue gas stream, the flue gas stream comprising flue gas carbon dioxide and the process gas carbon dioxide.

In another aspect, alone or in combination with any one of the previous aspects, the top gas separator is a fractional distiller, a pressure swing absorption unit (PSA), or a vacuum pressure swing absorption unit (VPSA). In another aspect, alone or in combination with any one of the previous aspects, the source of oxygen is provided by a cryogenic separator, a membrane separator, a pressure swing absorption unit (PSA), a vacuum pressure swing absorption unit (VPSA), a fractional distiller, or an air separation unit (ASU).

In another aspect, alone or in combination with any one of the previous aspects, the method further comprising processing the flue gas with a flue gas scrubber, the flue gas scrubber providing a carbon dioxide rich stream. In another aspect, alone or in combination with any one of the previous aspects, the method, further comprising receiving the carbon dioxide rich stream in a drying unit and/or further comprising compressing the carbon dioxide rich stream in a compressor.

In another aspect, alone or in combination with any one of the previous aspects, the compressor provides supercritical carbon dioxide to a geological sequestering pipeline. In another aspect, alone or in combination with any one of the previous aspects, the geological sequestering pipeline is coupled to one or more subterranean oil reservoirs, natural gas deposits, un-mineable coal deposits, saline formations, shale, and basalt formations.

In another aspect, alone or in combination with any one of the previous aspects, the method further comprising receiving the metalized iron in an electric arc furnace. In another aspect, alone or in combination with any one of the previous aspects, the electric arc furnace is configured to receive the metalized iron continuously or semi-continuously.

In another aspect, alone or in combination with any one of the previous aspects, the method is absent a reformer.

In another example a method of carbon dioxide emission reduction from a direct reduction of iron (DRI) process is provided, the method comprising: reducing iron oxides present in a reduction unit to iron metal; producing a top gas stream in the reduction unit comprising process carbon dioxide, water, unreacted reducing gas, and unreacted hydrocarbon fuel; introducing the top gas stream to a top gas scrubber coupled to the reduction unit, wherein the top gas scrubber provides a scrubbed gas stream comprising the process carbon dioxide, the unreacted reducing gas, and the unreacted hydrocarbon fuel; introducing the scrubbed gas stream to a top gas separator coupled to the top gas scrubber, where the top gas separator provides: a first stream from at least two streams, the first stream comprising the unreacted reducing gas and the unreacted hydrocarbon fuel with essentially no process carbon dioxide; and a second stream from the at least two streams, the second stream comprising essentially the process carbon dioxide; providing the first gas stream directly or indirectly to a process gas heater, alone or in combination with additional hydrocarbon fuel and/or a portion of the scrubbed gas stream, providing synthetic combustion air to the process gas heater, the synthetic combustion air comprising a mixture of the second stream and a source of oxygen with essentially no nitrogen, the process gas heater producing a flue gas stream comprising flue gas carbon dioxide and the process carbon dioxide; introducing the flue gas stream to a flue gas scrubber and providing a carbon dioxide rich stream; sequestering the carbon dioxide rich stream and reducing carbon dioxide emission from the reduction unit.

In one aspect, the top gas separator is a pressure swing absorption unit (PSA), chemical absorption unit, or vacuum pressure swing absorption unit (VPSA). In another aspect, alone or in combination with any one of the previous aspects, the source of oxygen is provided by a cryogenic separator, a membrane separator, a pressure swing absorption unit (PSA), a vacuum pressure swing absorption unit (VPSA), a fractional distiller, or air separation unit (ASU).

In another aspect, alone or in combination with any one of the previous aspects, prior to the sequestering, receiving the carbon dioxide rich stream in a drying unit and/or further comprising compressing the carbon dioxide rich stream in a compressor.

In another aspect, alone or in combination with any one of the previous aspects, the compressor provides supercritical carbon dioxide to a geological sequestering pipeline. In another aspect, alone or in combination with any one of the previous aspects, the geological sequestering pipeline is coupled to one or more subterranean oil reservoirs, natural gas deposits, un-mineable coal deposits, saline formations, shale, and basalt formations.

### BRIEF DESCRIPTION OF THE DRAWINGS

In order to understand and to see how the present disclosure may be carried out in practice, examples will now be described, by way of non-limiting examples only, with reference to the accompanying drawings, in which:

FIG. 1 is a schematic flow diagram illustrating the main steps for performing a DRI process with carbon dioxide sequestering in accordance with an aspect of the present disclosure.

FIG. 2 is an expanded view of portion 2 of FIG. 1 in accordance with an aspect of the present disclosure.

### DETAILED DESCRIPTION

This disclosure presents technical solution to the above technical problem of managing sources of carbon dioxide created during a direct reduction of iron process. Thus, the present disclosure provides a method to reduce or eliminate N2 from the flue gas stream generated in a process gas heater used in a direct reduction of iron process, by replacing conventional combustion air with a synthetic combustion air composed of a source of oxygen with essentially no nitrogen. In the presented method, by replacing conventional combustion air with the presently disclosed synthetic combustion air, substantially all of environmentally undesirable chemicals and impurities present in the process gas carbon dioxide stream are substantially decomposed and/or chemically destroyed during the combustion process. Moreover, the resulting flue gas leaving the process gas heater in the presented method will be mainly carbon dioxide with substantially reduced or eliminated nitrogen content; thus, eliminating or reducing further selective separation steps otherwise required to separate carbon dioxide from nitrogen. In other words, the presented method will provide a single high purity stream of carbon dioxide (carbon dioxide rich stream) configured for sequestration purposes and/or storage.

This disclosure provides for a DRI process that provides for the capability of producing “blue steel.” Whereas traditional processing of iron ore to make metallic iron results in as much as one ton of carbon dioxide emissions per ton of iron, the present disclosure provides for a process that results in essentially zero tons of carbon dioxide emissions per ton of iron.

The presently disclosed includes one or more apparatus for sequestering carbon dioxide from a DRI unit, for example, the system can comprise one or more conduits for dividing a top gas from the DRI unit; one or more conduits for mixing the top gas with a hydrocarbon fuel and forming a reducing gas; and one or more conduits for feeding the top gas into a carbon dioxide scrubber for removing at least some carbon dioxide from the top gas. The system can also include one more apparatus such as blowers, or gas compressors for compressing the process gas and the top gas, fuel and/or carbon dioxide. The system can still further include a wet scrubber for scrubbing the top gas to remove dust, water and sludge.

The top gas is obtained from the DRI unit. The presently disclosed system also includes a top gas separator, which produces a carbon dioxide rich gas stream. The presently disclosed system includes apparatus such as one or more conduits for mixing the carbon dioxide rich gas with a source of oxygen, to replace the combustion air used in the process gas heater. Optionally, a preheater for preheating the carbon dioxide rich gas before mixing it with the oxygen or fuel is used.

The process gas heater of the presently disclosed system produces flue gas. The presently disclosed system includes one or more apparatus for scrubbing the flue gas. Optionally, the system includes apparatus such as one or more conduits for using the flue gas to preheat another gas or to direct and/or recycle the flue gas.

The carbon dioxide sequestration processes of the present disclosure also provides an efficient continuous and/or close loop operation by which unreacted carbon monoxide and hydrogen from the DRI unit and expelled top gas may be recaptured, while minimizing unwanted emissions. Thus, the present disclosure provides for, in one example, a closed loop system where essentially pure carbon dioxide is sequestered. As a result, the present disclosure provides for the production of “blue iron” that when coupled with an electric arc furnace or the like ultimately provides “blue steel.”

Iron ore can be reduced to provide DRI using a reducing medium. In one example, the reducing medium can be a reducing gaseous mixture of hydrogen and carbon monoxide. In one example, gaseous mixture of hydrogen and carbon monoxide can be made by reforming and cracking hydrocarbon fuels at elevated temperatures. In one example, the reducing gas of mixed hydrogen and carbon monoxide is produced by heating hydrocarbon fuels in a process gas heater, and by introducing the heated gas to a reduction unit. In one example DRI inside the reduction unit can be used as the catalyst to advance reforming and cracking reactions. In one example natural gas can be used as the hydrocarbon fuel to form reducing gas.

Reducing gas can be generated inside the reduction unit by reforming and/or cracking natural gas in the presence of water vapor by the following general reaction schemes:

CH4<—>2H2+C Equation (I)

CH4+H2O<—>3H2+CO Equation (II)

CO+H2O<—>H2+carbon dioxide Equation (III)

In one example reducing gas is partially oxidized natural gas comprising a mixture of hydrogen and carbon monoxide, e.g., “syngas.” Syngas, when mixed with iron ore, acts as the reducing agent to reduce the iron ore by extracting oxygen from the ore. In one example, the syngas of mixed hydrogen and carbon monoxide is produced by the partial oxidation of natural gas or other hydrocarbons.

In one example, the reducing gas is generated from hydrocarbon fuels either externally in a reformer unit (reforming−catalytic or partial oxidation), or internally inside the reduction reactor using the metallic iron as catalyst (reforming+cracking). In one example, a reformer unit is not used in the present disclosure and the reduction reactor is used with the iron ore and/or iron metal as catalyst to provide reducing gas.

The reduction of iron oxide into DRI can be represented by the following general reaction schemes:

Fe2O3+3H2<—>2Fe+3H2O Equation (IV)

Fe2O3+3CO<—>2Fe+3carbon dioxide Equation (V)

The products of the DRI reactions leaving the reduction reactor are process carbon dioxide, water, unreacted hydrocarbon fuel plus unreacted H2 and CO, which is collectively referred to herein as “top gas.” It is desirable to substantially reduce or eliminate any carbon dioxide (process carbon dioxide or flue gas carbon dioxide) associated with DRI processes as carbon dioxide is a global warming gas. This present disclosure, in one example, provides for a method and system that substantially reduces and/or eliminates carbon dioxide emission to the atmosphere during the operation of a direct reduction of iron process.

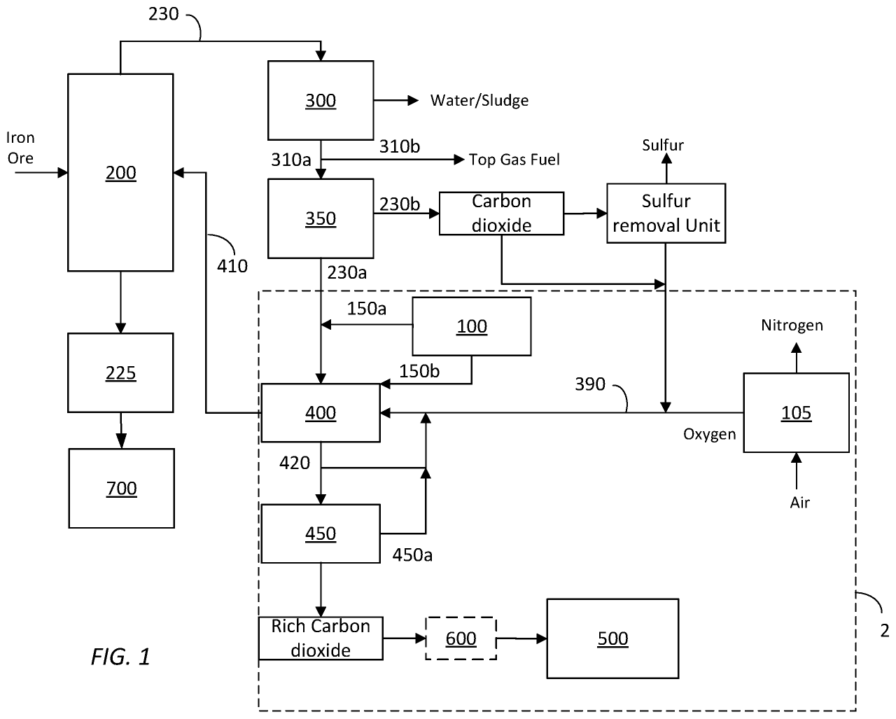

With reference now to the Figures, that depict a direct reducing iron (DRI) process, the presently disclosed system and method is described. With reference to FIG. 1, reducing gases 410 are provided to DRI unit 200 together with iron ore to facilitate the direct reduction of the iron ore and to provide metallic iron 225, for example, for use in steel making, as well as a top gas stream 230 which comprises, among other things, water, dust, particulate matter, unreacted reducing gases, sulfur, and carbon dioxide. In one example, DRI unit 200 is a conventional vertical shaft-type reduction furnace or the like. In one example, the DRI unit 200 includes a feed hopper (not shown) into which iron oxide (as pellets, lumps, or compacts) are delivered at a predetermined rate. At the bottom of the DRI unit 200 is a discharge pipe (not shown) providing metallic iron 225.

In one example, at approximately the midpoint of the DRI unit 200 heated reducing gas 410 is introduced at a temperature of between about 700 degrees C. and about 1150 degrees C. The heated reducing gas 410 comprises at least hydrogen, and carbon monoxide, methane, and water vapor that reduce the iron ore as discussed below. In one example, reducing gas 410 is essentially devoid of intentionally introduced nitrogen gas.

In one example, as the oxygen is sourced from an air separation process, the presently disclosed system eliminates or reduces the presence of nitrogen into the combustion system used to heat the reducing gas. The absence or reduced amount of nitrogen in the combustion system, that generates the flue gas 420 released from the process gas heater 400 has significant advantages in the production of metallic iron from ore, including but not limited to facilitating carbon dioxide capture from the combustion system and the reduction of NOx waste gas and iron nitride formation, among other things.

After introduction of the reducing gas stream 410 to DRI unit 200, unreacted hot reducing gas flows upwards through a reduction region of DRI unit 200, for example, counter to the flow of the (continuously introduced) iron ore, and exits the DRI unit 200 through a gas off-take pipe (not shown) at the top of the DRI unit 200 as top gas 230. Top gas 230 comprises, unreacted reducing gases together with water vapor, particulate matter, process carbon dioxide, and sulfur compounds.

Tog gas stream 230 exits DRI unit 200 and is introduced to scrubber unit 300, which is configured to remove water, sludge and/or particulate matter. In one example, top gas stream 230 leaving the scrubber unit 300, is split into at least two streams 310a, 310b. In one example, stream 310a is a scrubbed gas stream comprising the process carbon dioxide, the unreacted reducing gas, and the unreacted hydrocarbon fuel and is introduced to the top gas separator unit 350. In one example, stream 310b from the at least two streams is used as a fuel in the process gas heater 400 (not shown).

Any conventional process gas heater configuration can be used in the present disclosure. In one example, the process gas heater is configured to receive a fuel stream, the synthetic combustion air, oxygen, or oxygen-rich stream, and to combust the mixture so as to utilize the liberated energy from the combustion to impart heat energy to a resultant reducing gas stream exiting the process gas heater.

In one example, the process gas heater used is a conventional direct reduction plant heater that comprises two main sections, a combustion section (burners, fuel ducts, combustion air ducts, flue gas ducts, etc.), and a process section (tube bundles, etc.). In the combustion section, a mixture of a hydrocarbon stream (combustion fuel) 150b with a portion of the top gas fuel stream 310b from the reduction reactor, is combusted. In one example, conventional “combustion air” (80:20 nitrogen:oxygen) is replaced with a “synthetic combustion air” in the combustion section of the process gas heater. In one example, the synthetic combustion air is oxygen in combination with mainly process carbon dioxide, the balance being at least a portion of the recycle flue gas from the process gas heater.

Reduction reactions require a lot of heat (energy). Therefore, in one example, the direct reduction processes uses hot reducing gas for reduction purposes. In the present disclosure, the required energy (heating of the reducing gas) is supplied by a process gas heater (mainly from combusting a fuel source with oxygen) and/or combustion partial oxidation (slightly) occurring downstream of the process gas heater to provide additional heat to the reducing gas stream. Typically, a process gas heater using a combustion fuel source is capable of heating reducing gas to 900° C. In one example of the present disclosure, to increase the temperature of the reducing gas presented to the DRI unit, a small flow of oxygen with essentially no nitrogen is added to the hot reducing gas to initiate combustion of some of the recycled reducing gas. As a result, due to some amount of combustion of the hot reducing gas, the temperature of the process gas can rise to about 1100° C. before entering the reduction reactor.

The combusted fuel leaving the process gas heater as a “flue gas stream” comprises flue gas carbon dioxide, water, and impurities such as nitrogen, nitrogen oxides, sulfur oxides, and oxygen. In one example, the system and method of the present disclosure provides for the recycle of a portion of the hot flue gas 420, or cold flue gas 450a to control and/or moderate the flame parameters (e.g., temperature, height, etc.) in the process gas heater burners.

In conventional processes using conventional combustion air, the flue gas exiting the process gas heater comprises mainly nitrogen, because the majority of combustion air is nitrogen (˜80%), with the rest of the flue gas comprising flue gas carbon dioxide and water and minor amounts of completely or partially oxidized products. In contrast, the present disclosure, using the synthetic combustion air, eliminates the source of nitrogen and the resultant excess of nitrogen and its oxides from the flue gas. This simplifies the scrubbing of the flue gas in the presently disclosed process, which in turn, leads to economic benefit in the production of iron from iron ore, for example, the need to separate nitrogen from carbon dioxide is reduced or eliminated making carbon dioxide sequestering more economically feasible.

In one example, unreacted reducing gases leaving the DRI unit 200, and after passing thru top gas separator unit 350, is split into at least two streams 230a, 230b. In one example, a first stream 230a comprises unreacted reducing gas that is combined with hydrocarbon fuel 150a and then is delivered to process gas heater 400 for recycling. In one example, a second stream 230b from the at least two streams comprises a process carbon dioxide stream that is combined with an external oxygen stream 390 from air separation unit 105 to provide the synthetic combustion air, and then is introduced to the combustion system of the process gas heater 400. In one example, top gas separator second stream 230b, is delivered to sulfur removal unit whereas sulfur compounds can be separated and/or collected.

In one example, hydrocarbon fuel 100, which can be natural gas, is delivered to process gas heater 400 without the use of a reformer. In one example, hydrocarbon fuel 150a is mixed with first stream 230a from top gas separator 350 and delivered to process gas heater 400 for providing hot reducing gas 410 to DRI unit 200. In one example, hydrocarbon fuel 150b is delivered to the combustion system of the process gas heater 400 together with oxygen 390 from air separating unit 105. In another example, fuel 150b is delivered to process gas heater 400 together with oxygen 390 from air separating unit 105 substantially without nitrogen.

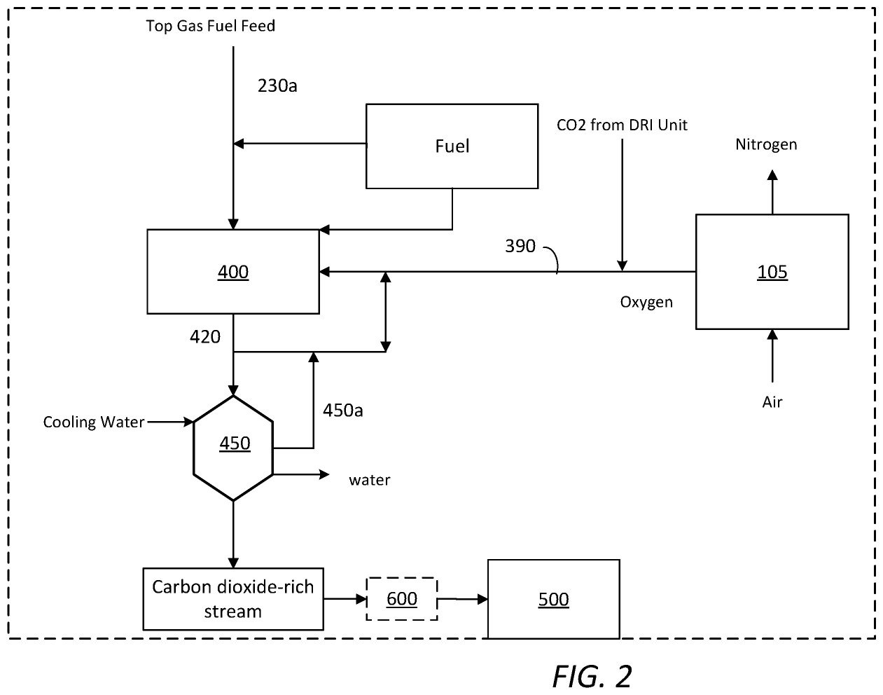

With reference to FIG. 2, depicting enlarged view of section 2 of FIG. 1, shows schematically an aspect of the present disclosure where a portion of hot flue gas 420 from the process gas heater combustion system is mixed with oxygen 390 from air separating unit 105 and process carbon dioxide from top gas 230 to replace the combustion air, thus facilitating capture of process carbon dioxide during the direct reduction of iron ore. In one example, water is condensed out of the top gas stream 230 via water-cooled scrubber unit 300, and the process carbon dioxide and unreacted reducing gases is then separated in top gas separator unit 350. Top gas separator unit 350 can include a cryogenic separator, a chemical absorption unit, a pressure swing absorption unit (PSA), or a vacuum pressure swing absorption unit (VPSA), and the like.

In one example, the external source of oxygen 390 is provided by air separating unit (ASU) 105. In one example air separating unit 105 is a fractional distiller, pressure swing absorption unit (PSA), chemical absorption unit, cryogenic separator, or vacuum pressure swing absorption unit (VPSA).

The hot flue gas stream 420 from process gas heater 400, as shown in FIG. 2, is introduced to flue gas scrubber 450 so as to provide a reduced temperature flue gas carbon dioxide rich stream 450a. Flue gas scrubber 450 as shown, for example, uses cooling water to quench and separate water from the hot flue gas stream 420.

In one example, optionally, a portion of the quenched flue gas 450a is recycled by combining with oxygen stream 390 being introduced to process gas heater 400 to provide a synthetic combustion air that is rich in carbon dioxide and lean or absent in nitrogen. In one example, the synthetic combustion air is about 20% oxygen, 70% carbon dioxide the balance being mainly water vapor. Using the synthetic combustion air composition as disclosed affects the thermodynamics of combustion in the process gas heater. Adjustments of one or more process gas heater parameters (e.g., flame temperature, flame height or length and/or flame-to-flame or burner-to-burner interactions) in the process gas heater can be used to balance adiabatic dynamics and/or control the temperature and pressure of the process gas stream sent to the DRI Unit 200. Adjustments of the one or more process gas heater parameters can be by computer modeling.

In one example, optionally, the operating conditions used in the presently disclosed system include a natural gas fuel 150b provided at about 15-25K Nm3/hour, utilizing top gas fuel 310b at about 15-25K Nm3/hour, and oxygen from an air separating unit 390 at about 55-65K Nm3/hour. Optionally, the operating conditions used in the presently disclosed system can be based on about 40-50K Nm3/hour of carbon dioxide rich stream from the top gas separator unit 350, when mixed with about 60K Nm3/hour oxygen from the ASU stream to form an oxygen rich stream. Optionally, the operating conditions used in the presently disclosed system include mixing the oxygen rich stream with about 180-230K Nm3/hour hot flue gas 420 from the process gas heater 400 to form synthetic combustion air that is about 20-30% oxygen, about 50-70% carbon dioxide the balance being water vapor available for delivery to the process gas heater 400. In one example, about 80-90 K Nm3/hour of carbon dioxide-rich flue gas is presented to compressor 600 for dehydration and sequestration. In one example, optionally, the operating conditions used in the presently disclosed system is capable of sequestering approximately 150 tons per hour of carbon dioxide during operation of a conventional DRI unit.

In one example, the reduced iron 225 from the DRI Unit 200 is delivered to an electric arc furnace (EAF) 700. In another example, the reduced iron 225 is delivered directly to the electric arc furnace 700. In another example, the reduced iron 225 is delivered continuously or semi-continuously to the electric arc furnace 700.

In one example, the presently disclosed system is coupled via pipeline to a carbon dioxide geological sequestering unit 500. carbon dioxide is geologically sequestered into one or more subsurface and/or subterranean structures. In one example, the one or more subsurface and/or subterranean structures are deeper than colluvium or alluvium layers or subterranean fresh water. In one example, byproduct carbon dioxide is geologically sequestered into subsurface and/or subterranean structures that include but are not limited to, subterranean oil reservoirs sandwiched between confinement layers, natural gas deposits, un-mineable coal deposits, saline formations, shale, and/or basalt formations (not shown).

While certain embodiments of the present disclosure have been illustrated with reference to specific combinations of elements, various other combinations may also be provided without departing from the teachings of the present disclosure. Thus, the present disclosure should not be construed as being limited to the particular exemplary embodiments described herein and illustrated in the Figures, but may also encompass combinations of elements of the various illustrated embodiments and aspects thereof.

100: fuel source

105: Air Separation Unit

200: Direct Reducing Iron Unit

225: Direct Reduced Iron product

300: Top Gas Scrubber

350: Top Gas Separator

400: Process Gas Heater

450: Flue Gas Scrubber

500: carbon dioxide sequestering Unit

700: Electric Arc Furnace.

We claim:

1. A system for reduction of metal oxides, comprising:
a reduction unit configured to reduce iron oxides to metallic iron;
a process gas heater coupled to the reduction unit, the process gas heater configured to supply the reduction unit directly with a source of heated reducing gas, wherein the process gas heater is further configured to receive a synthetic combustion air stream for heating the reducing gas, the synthetic combustion air stream comprising a source of oxygen with essentially no nitrogen.

2. The system of claim 1, wherein the reduction unit provides a top gas stream comprising process carbon dioxide, water, unreacted reducing gas, and unreacted hydrocarbon fuel.

3. The system of claim 2, wherein the system further comprises a top gas scrubber coupled to the reduction unit and a top gas separator coupled to the top gas scrubber, wherein the top gas scrubber provides a scrubbed gas stream comprising the process carbon dioxide, the unreacted reducing gas, and the unreacted hydrocarbon fuel to the top gas separator and/or to the process gas heater.

4. The system of claim 3, wherein the top gas separator provides a first stream from at least two streams, the first stream comprising the unreacted reducing gas and the unreacted hydrocarbon fuel with essentially no process carbon dioxide, and a second stream from the at least two streams, the second stream comprising essentially the process carbon dioxide.

5. The system of claim 4, wherein the first stream is provided directly or indirectly to the process gas heater, alone or in combination with additional hydrocarbon fuel.

6. The system of claim 4, wherein the second stream is combined with the source of oxygen.

7. The system of claim 3, wherein the top gas separator is a pressure swing absorption unit (PSA), chemical absorption unit, or vacuum pressure swing absorption unit (VPSA).

8. The system of claim 1, wherein the source of oxygen of the synthetic combustion air stream is provided by a cryogenic separator, a membrane separator, a pressure swing absorption unit (PSA), a vacuum pressure swing absorption unit (VPSA), a fractional distiller, or air separation unit (ASU).

9. The system of claim 1, further comprising a flue gas scrubber configured to receive flue gas comprising the process carbon dioxide and flue gas carbon dioxide, the flue gas scrubber providing a carbon dioxide rich stream.

10. The system of claim 9, wherein at least a portion of the flue gas is mixed with the synthetic combustion air stream.

11. The system of claim 1, further comprising a drying unit configured to receive the carbon dioxide rich stream and/or further comprising a compressor configured to receive and compress the carbon dioxide rich stream.

12. The system of claim 11, wherein the compressor is configured to provide supercritical carbon dioxide to a geological sequestering pipeline.

13. The system of claim 12, wherein the geological sequestering pipeline is coupled to one or more subterranean oil reservoirs, natural gas deposits, un-mineable coal deposits, saline formations, shale, and basalt formations.

14. The system of claim 1, further comprising an electric arc furnace configured to receive the metallic iron.

15. The system of claim 14, wherein the electric arc furnace is configured to receive the metallic iron continuously or semi-continuously.

16. The system of claim 1, wherein the system is absent a reformer unit.

17. A method of direct reduction of iron (DRI) in a reduction unit configured to reduce iron oxides to metalized iron, the method comprising:
providing to a reduction unit a source of heated reducing gas from a process gas heater;
producing a top gas stream comprising process carbon dioxide, unreacted reducing gas, unreacted hydrocarbon fuel, and water;
providing a synthetic combustion air stream to the process gas heater, the synthetic combustion air stream comprising a source of oxygen with essentially no nitrogen; and
reducing iron oxides present in the reduction unit to iron metal.

18. The method of claim 17, wherein the reduction unit produces a top gas stream comprising process carbon dioxide, unreacted reducing gas, unreacted hydrocarbon fuel, and water and wherein the method further comprises:
introducing the top gas stream to a top gas separator configured to split the top gas into at least two streams: a first stream comprising the unreacted reducing gas, and the unreacted hydrocarbon fuel with essentially no process carbon dioxide; and a second stream comprising the process carbon dioxide;
combining the first stream with fuel and sending to the process gas heater; and
combining the second stream with the source of oxygen and sending to the process gas heater;
wherein the process gas heater provides a flue gas stream, the flue gas stream comprising flue gas carbon dioxide and the process gas carbon dioxide.

19. The method of claim 18, wherein the top gas separator is a fractional distiller, a pressure swing absorption unit (PSA), or a vacuum pressure swing absorption unit (VPSA).

20. The method of claim 17, wherein the source of oxygen is provided by a cryogenic separator, a membrane separator, a pressure swing absorption unit (PSA), a vacuum pressure swing absorption unit (VPSA), a fractional distiller, or an air separation unit (ASU).

21. The method of claim 17, further comprising processing the flue gas stream with a flue gas scrubber, the flue gas scrubber providing a carbon dioxide rich stream.

22. The method of claim 21, further comprising receiving the carbon dioxide rich stream in a drying unit and/or further comprising compressing the carbon dioxide rich stream in a compressor.

23. The method of claim 22, wherein the compressor provides supercritical carbon dioxide to a geological sequestering pipeline.

24. The method of claim 23, wherein the geological sequestering pipeline is coupled to one or more subterranean oil reservoirs, natural gas deposits, un-mineable coal deposits, saline formations, shale, and basalt formations.

25. The method of claim 17, further comprising receiving the metalized iron in an electric arc furnace.

26. The method of claim 25, wherein the electric arc furnace is configured to receive the metalized iron continuously or semi-continuously.

27. The method of claim 17, wherein the method is absent a reformer.

28. A method of carbon dioxide emission reduction from a direct reduction of iron (DRI) process, the method comprising:
reducing iron oxides present in a reduction unit to iron metal;
producing a top gas stream in the reduction unit comprising process carbon dioxide, water, unreacted reducing gas, and unreacted hydrocarbon fuel;
introducing the top gas stream to a top gas scrubber coupled to the reduction unit, wherein the top gas scrubber provides a scrubbed gas stream comprising the process carbon dioxide, the unreacted reducing gas, and the unreacted hydrocarbon fuel;
introducing the scrubbed gas stream to a top gas separator coupled to the top gas scrubber, wherein the top gas separator provides: a first stream from at least two streams, the first stream comprising the unreacted reducing gas and the unreacted hydrocarbon fuel with essentially no process carbon dioxide; and a second stream from the at least two streams, the second stream comprising essentially the process carbon dioxide;
providing the first gas stream directly or indirectly to a process gas heater, alone or in combination with additional hydrocarbon fuel and/or a portion of the scrubbed gas stream;
providing synthetic combustion air to the process gas heater, the synthetic combustion air comprising a mixture of the second stream and a source of oxygen with essentially no nitrogen, the process gas heater producing a flue gas stream comprising flue gas carbon dioxide and the process carbon dioxide;
introducing the flue gas stream to a flue gas scrubber and providing a carbon dioxide rich stream;
sequestering the carbon dioxide rich stream and
reducing carbon dioxide emission from the reduction unit.

29. The method of claim 28, wherein the top gas separator is a pressure swing absorption unit (PSA), chemical absorption unit, or vacuum pressure swing absorption unit (VPSA).

30. The method of claim 28, wherein the source of oxygen is provided by a cryogenic separator, a membrane separator, a pressure swing absorption unit (PSA), a vacuum pressure swing absorption unit (VPSA), a fractional distiller, or air separation unit (ASU).

31. The method of claim 28, wherein prior to the sequestering, receiving the carbon dioxide rich stream in a drying unit and/or further comprising compressing the carbon dioxide rich stream in a compressor.

32. The method of claim 31, wherein the compressor provides supercritical carbon dioxide to a geological sequestering pipeline.

33. The method of claim 32, wherein the geological sequestering pipeline is coupled to one or more subterranean oil reservoirs, natural gas deposits, un-mineable coal deposits, saline formations, shale, and basalt formations.
